(19) United States
(12) Patent Application Publication
(10) Pub. No.: US 2020/0129017 A1
(43) Pub. Date: Apr. 30, 2020

(54) ROBOTIC DEVICE

(71) Applicant: ERYLON, AIX-EN-PROVENCE CEDEX (FR)

(72) Inventors: Emmanuel ROBERT, TRETS (FR); Eric PUYDEBOIS, CABRIES (FR); Baptiste BERNARD, MARIGNANE (FR); Dimitri PAOLINO, AIX EN PROVENCE (FR)

(21) Appl. No.: 16/618,513

(22) PCT Filed: May 14, 2018
(86) PCT No.: PCT/FR2018/000116

§ 371 Date: Dec. 2, 2019

(30) Foreign Application Priority Data
Jun. 2, 2017 (FR) 1754915

(51) Int. Cl. A47L 1/02; B62D 57/024

(52) U.S. Cl. CPC A47L 1/02; B62D 57/024

(57) ABSTRACT

The invention relates to a device (10), in particular for cleaning a glass surface, comprising a frame (12) carrying at least one rolling member (22, 24) and at least first (14) and second (16) members for applying a vacuum to a surface (18) connected to means for supplying a vacuum, the first (14) and second (16) members being independently of one another movably mounted on the frame (12) between a first position in which they are adapted to come into contact with a surface (18) of an object to apply a vacuum thereto and a second position in which they are remote from said surface (18), the device further comprising means (21) for controlling the vacuum of each of the first (14) and second (16) members in their first position configured to ensure permanent sliding contact on the surface (18).

### FIELD OF THE INVENTION

This invention relates to a robotic device capable of moving on a surface, for example a surface of an object that may be flat or curved or that surface may be a glass surface of a building.

### TECHNICAL BACKGROUND

Many robotic devices capable of moving on curved surfaces are known from the previous technique. More specifically, a device, intended for cleaning a vertical surface of a building, comprising a frame comprising rolling members, cleaning means as well as propellers applying the wheels and cleaning means in contact with the surface to be cleaned, are known. Although simple to operate, this type of device does not achieve a permanent physical connection between the surface and the device, so that a high degree of insecurity of use remains as well as an uneven cleaning quality.

In another known device, the device is held in contact with the surface by suction cups carried by a deformable frame. However, the suction cups provide a simple hanging here and the displacement of the device is achieved by the deformation of the frame and a succession of applications and releases of the suction cups. However, this type of device is long and complex to operate.

It is also known from document WO01/60638 that a device comprising one or more suction cup(s) connected to means for providing a vacuum is known. The vacuum in the suction cup is controlled so that it is firmly applied to the surface and sliding is allowed on the surface by injecting a lubricant around the periphery of the suction cup. While this device allows the device to slide on the surface while maintaining constant contact therewith, it does not allow obstacles on the surface to be passed.

It should be noted that it would still be possible to use magnetic force to apply the device to the surface. However, since the glass surfaces are non-magnetic, it is then necessary to create the magnetic attraction force through the surface by placing a magnet on the side opposite the device which must include a magnetic part sufficient to hold the device on the surface. However, this device does not allow the floors of a building to be crossed while remaining plated on the surface.

Thus, it is understandable that none of the devices described above offer a solution that allows simple and fast movement over a surface while allowing obstacles to be passed.

### SUMMARY OF THE INVENTION

For this purpose, a device is thus described in particular for cleaning a glass surface, comprising a frame carrying at least one rolling member and at least first and second members for applying a vacuum to a surface connected to means for supplying a vacuum, the first and second members independently of one another movably being mounted on the frame between a first position in which they are able to come into contact with a surface of an object to apply a vacuum thereto and a second position in which they are moved away from said surface, the device preferably comprising means for controlling the vacuum of each of the first and second members in their first position configured to ensure permanent sliding contact on the surface.

According to the invention, the first and second members for applying a vacuum are displaceably mounted on the frame in such a way as to allow an engagement on a surface of an object in a first position or a spacing of the surface of said object from being engaged in a second position, thus allowing obstacles that would be formed on the surface on which the device is to move to be easily passed. Of course, when there are several rolling members, the axes of rotation of the rolling members are all parallel to each other.

The device according to the invention also allows a simple movement on a surface which it is applied on by making a sliding movement of the first and second members on the surface. In this configuration, the first and second vacuum application members are movable relative to the frame carrying the rolling member(s) and are therefore movable relative to the rolling member(s).

The support of the first and second members for applying a vacuum to the frame, i.e. including a rolling member, allows the first and second members to move between the first and second positions.

To move the device, it includes means for hanging the frame on a stationary structure. Thus, when one wishes to move the device on a vertical surface, for example glass, the stationary structure can be that of the top of a building for example and the hanging means, including for example a wire/cable, thus make it possible to maintain the device and move it in height in particular.

According to another characteristic, the device includes means for measuring the vacuum applied by each of said at least first and second members, these measuring means forming an input of the control means, which makes it possible to automatically regulate the vacuum applied by each of the first and second members to the surface and thus best control the sliding on the surface in real time.

According to yet another characteristic, the control means are configured so that each of the first and second members applies, in their first position, a vacuum ΔP₂ such that:

T/N>k, where
T represents the tangential force (in Newton) at the surface considered which is a function of the weight of the device,
N represents the normal effort (in Newton) at the surface considered and
k represents the sliding coefficient between the member of application of the vacuum and the surface under consideration.

It is understood that the sliding coefficient is more specifically a function of the material of the vacuum application member that is in contact with the surface of the object and the material of the surface of the object on which sliding is desired. To control the sliding of the suction cup, it is understood that it is sufficient to control the force N applied to the considered surface of the object, i.e. the vacuum applied by each of the first and second vacuum application members. For a given torque formed by the material of the vacuum application member (suction cup material as shown below) and the surface (e.g. the glass of a building) which the device is to slide on, the sliding coefficient can be measured and corresponds to k=tan(∝) where ∝ corresponds to the angle from which sliding is obtained.

Preferably, the first and second vacuum application members each include a suction cup intended to be applied to a surface of an object, and the internal chamber of which is connected to the vacuum providing means.

Thus, when the suction cup has a surface for S applying the vacuum to the object which the device is to slide on, N it is defined as being equal to ΔP₂×S where s represents the vacuum applied to the surface ΔP₂ of the object. Therefore, the sliding condition is as follows: ΔP₂<T/(k×S) T and k being as indicated above.

Preferably the suction cup is bellows type to adapt to misalignment between the frame and the surface before they are connected. It includes an elastically deformable annular skirt.

In a practical embodiment of the invention, the suction cups are each fixed at the end of a rod fixed to a piston hermetically separating a first and a second chamber provided in a cylinder body, and in which:
i) the first chamber houses a return, for example elastic, member for the suction cup in its first position and the second chamber is connected to means for applying a back pressure controlled by the control means so that it can be greater than the return force so as to allow the suction cup to be positioned in its second position when the vacuum is cancelled in the suction cup chamber and so as to allow movement of the frame to bring the rolling member(s) into contact with the surface when the suction cups are in their first position, or
ii) the second chamber houses a return, for example elastic, member for the suction cup in its second position and the first chamber is connected to means for applying a back pressure controlled by the control means, so that it can allow the suction cup to be positioned in its second position and in its first position with the rolling members in contact with the surface.

The second case (ii) has the advantage that in the event of a power failure of the pressurisation/depressurisation means, then the return member ensures passive operation and allows the suction cups to be brought into their second position, preventing the device from remaining blocked on a surface, for example a glass surface of a building.

The return member works here in compression in the two variants proposed here. It can be a coil spring, for example.

More specifically, the rod can be hollow and can fluidly connect the internal chamber of the suction cup to the chamber of the cylinder housing the return member, which chamber is fluidly connected to the vacuum providing means.

This configuration simplifies the fluid connection between the suction cup chamber and the vacuum providing means by using existing parts of the device to achieve the fluid connection. Also, the rod is preferably mounted so that it can rotate around the axis of the cylinder body, which allows the movement of the frame to be decoupled from the movement of the suction cups in the plane.

In a particular embodiment consisting of a specific dimensioning of the suction cup and each associated cylinder, the depression application surface of each of said suction cups is dimensioned so that the force N is very large relative to the counter-pressure force F and wherein the volume of the chamber of each suction cup is very large relative to the volume variation that the first chamber of the cylinder undergoes between a first positioning of the device in which the rolling member(s) are supported on a surface on which the suction cups are in their first position and a second positioning of the device in which the rolling member(s) are positioned on a projecting part of the surface, such as a cross member of a glass surface of a building, the first and second suction cups being in their first position.

The term “very large relative to” here refers to at least three times larger. This dimensioning of each suction cup relative to its cylinder allows a slide control by the sole realization of a test to verify the absence of disbonding or anti-lifting when the suction cups are put in their first sliding position.

Indeed, to control the sliding of the suction cup, it is enough to control the force N. However, effort control alone is not N sufficient since it is not constant. Indeed, when passing an obstacle on the surface such as a crossbar, the wheels move away from the surface, i.e. windows in the case of a building, and therefore the cylinders see their position modified by a certain stroke c. Changing the stroke of the cylinders, when the suction cups are in their first position, has two consequences depending on whether you are in case i) or case ii) above.

It should be noted that in the case of the assembly of case i), the force R exerted by the return member (in the first chamber) on the piston is opposed to the force F₁ exerted by the pressure P₁ in the second chamber or back pressure on the piston surface S₁. Similarly, in the assembly of case (ii), the force R exerted by the return member in the second chamber on the piston is opposed to the force F₁ exerted by the pressure P₁ on S₁ in the first chamber, so that whatever the assembly (i) or (ii) their respective roles (getting the rod in or out of the cylinder) are equivalent. It should also be noted that in case ii), the return member is chosen to exert a plating R force of the rolling members on the surface, which is equivalent to that required in the assembly of case i), i.e. R=F≈P₁×S₁.

In case i), the variation of the c induced stroke:
a change in the value of the depression ΔP₂ (since the volume of the first chamber increases) which increases N and
an increase in pressure in the second chamber of the cylinder in proportion to the variation in stroke c (the effort of the recall device will decrease). This increase in pressure results in more pressure being applied to the suction cup. The new effort F=ΔP₁×S₁ which can lead to its disbonding when F>N.

In case (ii):
on the one hand, this leads to a decrease in the value of the vacuum (since ΔP₂ the volume of the second chamber decreases) which reduces the normal N effort and makes it easier to detach,
on the other hand, since the pressure in the cylinder ΔP₁ chamber is zero, the force of the return member will increase in proportion to this variation in the stroke that c can lead to disbonding when (because F>N N it is reduced).

Thus, to avoid disbonding and ensure sliding, a suction cup with a large surface S can be chosen so that the force N is very high in front F. In order to have little N variation according to the cylinder stroke, a suction cup with a large volume compared to the volume variation of the cylinder chamber (c×S₂) is chosen. Thus the vacuum P₂ varies little according to c and the force N is relatively constant despite the displacement of the cylinder according to the stroke c.

In conclusion, for configuration (i) or (ii), the vacuum ΔP₂ must be large enough (ΔP₂>F/S) so that there is no disbonding, but not too high(T/(k·S)>P₂). It is thus possible to size the suction cup and cylinder in such a way that they always have:

T/k<ΔP₁×S₁, where
ΔP₁ represents the overpressure in the chamber not housing the return member, and
S₁ represents the surface which said overpressure is applied on.

As a result, only the anti-lifting test F<N remains to be monitored.

In another embodiment, the suction cup can be connected to the vacuum supplying means by a flexible cord opening at its downstream end into the suction cup chamber. However, it is understood that this embodiment has the disadvantage of requiring the addition of a flexible cord on the suction cup that may hinder the movement of the device. This is not the case with the device comprising a hollow fluidic bonding rod, mentioned above.

The vacuum providing means a may include a venturi fluid circuit. Other means can also be used, such as a vacuum pump. Said at least one rolling member of the device may be formed by a wheel and the device according to the invention may include four of them.

In a particular embodiment, the rolling member(s) could be formed by cleaning rolling members, thus ensuring a rolling and cleaning function.

In order to pass all types of straight and substantially perpendicular obstacle configurations, it is desirable that the device include at least three vacuum application members that together delimit the vertices of a triangle. This triangular shape must be such that it allows the suction cups to be sufficiently spaced from each other to allow an obstacle to be passed.

However, if the dimensions of the device prevent sufficient spacing between the members for applying a vacuum, it is preferable that the device include at least two rolling members and at least two, preferably three, members for applying a vacuum are located in the same plane substantially perpendicular to the axes of rotation of the rolling members and containing the centre of gravity of the device.

This configuration makes it possible to centre the members applying a vacuum in the device and to limit the rolling effects that would be caused by the movement of a member in its second position.

Preferably, the device shall comprise at least five vacuum application members aligned as above.

This number of vacuum providing members allows you to move from one surface to another for a wide range of surface dimensions and crosspieces.

Indeed, if we consider that at least two members for applying a vacuum or suction cups are necessary in permanent contact so that in case of loss of a member there is at least always one attached to the surface, then at least two members for applying a vacuum or suction cups are necessary for a continuous surface and at least three members for two surfaces each spaced from the next by the height separating the surfaces and to be passed. Thus, for a building with a succession of identically spaced surfaces (windows for example in the case of a building), the overall distance of two members must be less than the height of the surfaces (or windows). This condition therefore combines with the previous one to reach the situation that, to have at least two suction pads in permanent contact with each other that must pass crosspieces of different widths separating surfaces (or panes) of different heights, it is shown with similar reasoning that five vacuum application devices allow both the smallest surfaces and the largest crosspieces to be passed.

Preferably, the device comprises at least one arm carrying a cleaning roller that can be held against a surface of an object, for example by elastic means.

Advantageously, the device includes means for spraying a cleaning liquid configured to spray the liquid onto the surface of an object. The spraying means can be positioned so that the cleaning liquid is sprayed upstream of the cleaning roller relative to a direction of movement of the device.

Also, the roller can have an axis substantially parallel to said at least one rolling member and mounted at one end of the frame with respect to a direction of movement of said device, the arm being rotatably articulated on the frame around an axis parallel to the axis of rotation of said at least one rolling member and the elastic support means ensuring an application of the roller on the surface.

The roller can be rotated by motorized means configured to rotate the roller in a counter-clockwise direction when looking at a left lateral flank of the device.

According to the specific configuration indicated, the roller is designed to rotate in a particular direction that ensures obstacle passing in all circumstances. Thus, when the device is arranged so that the roller is at an upper end thereof, the particular direction of rotation of the roller ensures an obstacle passing when going up and the elastic means ensures an obstacle passing when going down.

The arm comprises a degree of freedom in rotation about an axis substantially parallel to the axis of rotation of said at least one rolling member.

This configuration avoids the problems of hyperstatism of contact of the rolling members with the surface which one wishes to slide on, by allowing a rotation (rolling) about an axis substantially perpendicular to the axes of rotation of the rolling members. This problem is particularly important when the device includes four rolling members.

It should be noted that the contact areas with the surface of said at least two rolling members together define a plane through which the members for applying a vacuum are mounted to move, so that the members for applying the vacuum can be arranged:
on the same side of said plane as, and at a distance from, the rolling members,
on the same side of said plane as the rolling members and with a vacuum application end located in said plane, and
on the other side of said plane and at a distance therefrom.

This configuration allows an initial gripping by suction of the vacuum application members on a flat or substantially flat surface of the object without the rolling members applying any force to the surface of the object. Thus, first of all, the members applying a vacuum are moved to a position in which they are located on the other side of said plane with respect to the rolling members so that they come into contact with the surface, the rolling members not being in contact with the surface of the object. Thus, the plane delimited by the contact areas of the rolling members is located at a distance from the surface of the object. A vacuum controlled by the control means is then applied in such a way as to cause the vacuum application devices to slide. Then, in a second step, the frame is brought closer to the surface to bring the rolling member(s) into contact with the surface.

The members for applying a vacuum can be mounted to move in a direction substantially perpendicular to said plane.

This document also relates to a method for moving the device as described above, on a surface of an object having an obstacle, comprising the following steps:
a) the first and second members being in their first position, controlling the movement of the first member from its first position to its second position,
b) sliding the device in a given direction so that the obstacle is located between the first and second members in that direction,
c) controlling the movement of the first member from its second position to its first position,
d) controlling the movement of the second member from its first position to its second position,
e) slidingly controlling the device in the same said given direction so that the first member and the second member are located on the same side of said obstacle in said direction,
f) controlling the movement of the second member from its second position to its first position.

Alternatively, step b) can be performed using one or more cable(s) to connect to the device frame.

Also involved is a method for moving the device described above, including a step of:
Sliding the device facing a surface so that the members applying a vacuum can come into contact with the surface, the roller being arranged at an upper end of the device,
Rotating the roller in the direction of rotation tending to raise the device upwards.

This configuration is particularly advantageous since when the device is carried by hanging means such as a cable on the roof of a building for example, a traction on the device via a suspension system mounted on the roof, allows the rotation of the roller to be in the direction of movement leading to it easily passing an obstacle such as a crossbar. When the device is, for example, at the top of the building, and it is desired to lower it by means of the suspension device, although the roller rotates in a direction opposing the descent, the passage of an obstacle such as a crossbar is not difficult since the elastic support means ensure that the roller escapes. Thus, whether the device is moved up or down, the roller, which is advantageously a cleaning roller, is never blocked in the angle formed by the building surface and the obstacle, i.e. a crossbar for example. It is understood that when the device is moved upwards, it is the particular direction of rotation of the roller that helps to pass the obstacle and to descend, the elastic support means ensure that the obstacle is passed.

The document still relates to a method comprising the following steps:
Arranging the device opposite a surface so that the members applying a vacuum can come into contact with the surface, the first and second suction cups being moved to their first position and a vacuum being created in the chamber of each suction cup,
Moving the frame so as to apply the rolling member(s) to the surface,
Measuring the pressure value in the chamber housing the return member,
Establishing whether the vacuum ΔP₂ in the chamber housing the return member is such that ΔP₂>ΔP₁×S₁/S,
   where ΔP₁ represents the overpressure in the other chamber,
   S₁ represents the surface which the overpressure ΔP₁ is applied on, and
   S represents the surface of the object which the depression ΔP₂ is applied on.
If so, stop increasing the value of ΔP₂
If not, continue to increase the value by ΔP₂.

The invention will be better understood and other details, characteristics and advantages of the invention will appear when reading the following description, which is given as a non-limiting example, with reference to the attached drawings.

### BRIEF DESCRIPTION OF THE FIGURES

FIG. 1 is a schematic view of a device according to the invention;

FIG. 2 is a schematic view of a hydraulic circuit intended to be used with the device of FIG. 1;

FIG. 3 is a schematic view of an alternative hydraulic circuit of FIG. 2,

FIGS. 4A to 4E illustrate a complete sequence of movement of the device in FIG. 1;

FIG. 5 is a schematic top view of an alternative embodiment according to the invention;

FIGS. 6A1, 6A2, 6A3 and FIGS. 6B1, 6B2, 6B3 represent two variants of a cylinder and a suction cup according to the invention, the variant of FIGS. 6B1, 6B2, 6B3 already being represented mounted in a hydraulic circuit in FIG. 2, FIGS. 6A1, 6A2 and 6A3 representing different positions of a cylinder according to one embodiment and FIGS. 6B1, 6B2 and 6B3 representing different positions of a cylinder according to another embodiment;

FIGS. 7A and 7B represent the movement of the cylinders from their second position to their first sliding position;

FIG. 8 shows one particular embodiment of the invention;

FIGS. 9A and 9B represent the up and down motions of a device on a substantially flat surface of a building, for example.

### DETAILED DESCRIPTION

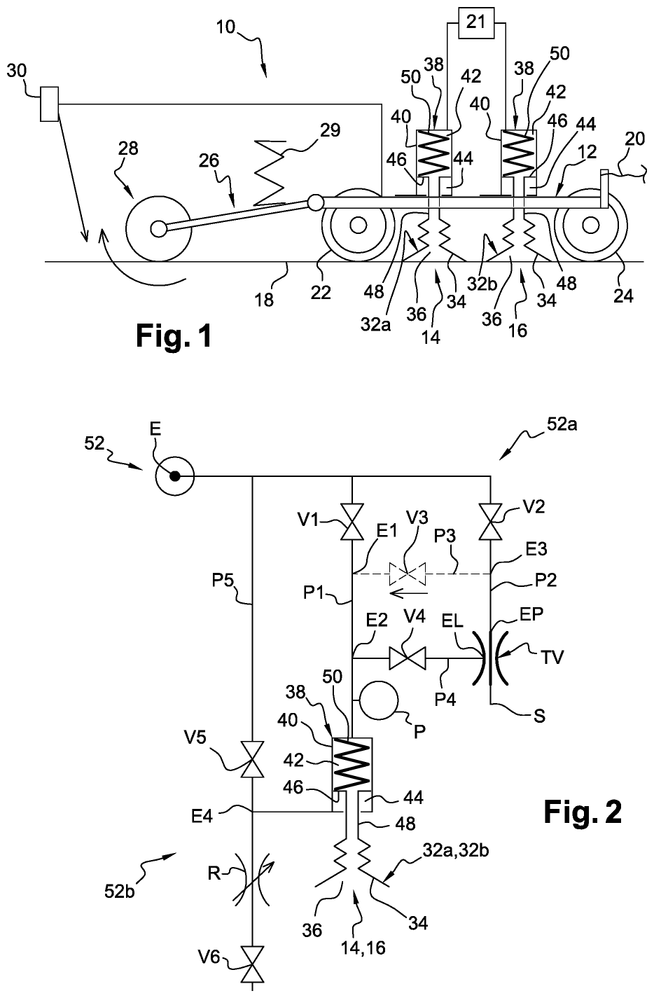

First of all, reference is made to FIG. 1, which represents a device 10 for cleaning a glass surface of a building, which includes a frame 12 carrying two members 14, 16 for applying a vacuum to a surface 18 which the device 10 is required to move on. Of course, the device 10 can include more than two members for the application of a vacuum as will be explained in reference to FIG. 5. The frame 12 includes means for hanging 20 on a stationary part of the object which the device 10 is to be moved on. These hanging means 20 include, for example, a cable. Where the device is intended to slide on a vertical surface of a building, the stationary part may be formed by the roof of the building carrying the device.

The first 14 and second 16 members are displaceably mounted relative to the frame 12 so that they can come into contact with the surface 18 in a first position or, on the contrary, be moved away therefrom in a second position and are displaceably controlled by control means 21. The frame 12 carries at least one rolling member, preferably at least two rolling members 22, 24 arranged at its axial ends in a direction of travel. These rolling members are wide enough to ensure stability of the device and prevent it from tipping over. In practice, it could include three small rolling members, the stability of which can be achieved by the relative positioning of the rolling members relative to each other, for example in a triangle configuration. These rolling members 22, 24 are for example wheels. The device 10 also includes an arm 26 formed at a front end in the direction of descent and carrying a rotating device such as a cleaning device 28 which is more specifically a cleaning roller for example which may include a strip of microfibre material which allows simple and quick cleaning of a surface with a limited amount of cleaning water. The roller is driven in rotation by a motor (not shown). When the roller is a cleaning roller, the direction of the roller is such that it pushes water down the building. Water, preferably osmosed water spraying means 30, are carried by the frame 12 and shaped in such a way as to allow water to be sprayed upstream of the roller 28 relative to the direction of movement of the device 10. The device can carry a water storage tank to avoid having a fluid connection from the device to an external power supply external circuit that would complicate its use. Advantageously, the arm 26 is hinged to rotate on the frame 12 around an axis parallel to the axes of rotation of the rolling members and for example elastic support means 29 make it possible to maintain the cleaning roller 28 in contact with the surface 18 which the device 10 is moved on to carry out the cleaning thereof.

As well represented in FIG. 1, each first member 14 and second member 16 for applying a vacuum comprises a suction cup 32a, 32b having an elastically deformable skirt 34 intended to be applied to a flat or curved surface 18 and delimiting an internal chamber 36 in which a vacuum is formed to maintain the device 10 in permanent sliding contact on the surface 18.

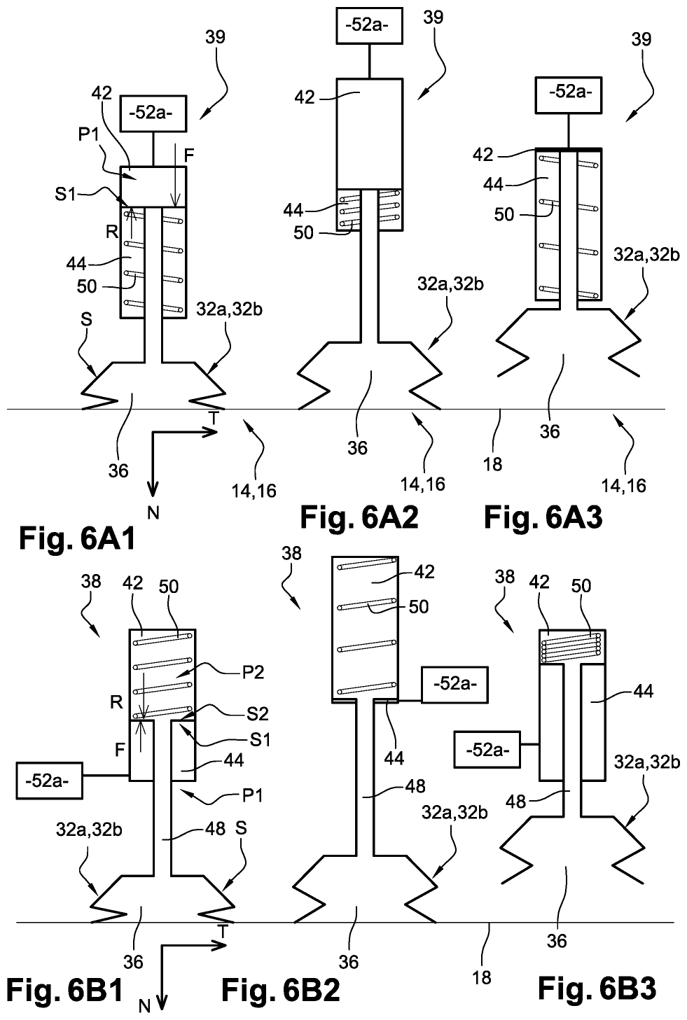

The movement of each suction cup 32a, 32b between a first position in which it ensures permanent sliding contact on the surface 18 and a second position in which the suction cup 32a, 32b is remote from the surface 18, is carried out by means of a cylinder 38 the body 40 of which includes a first chamber 42 and a second chamber 44 hermetically separated from each other by a piston 46, a rod 48 connecting the piston 46 to the skirt 34 of the suction cup 32a, 32b. The rod 48 which is hollow here passes through the second chamber 44 and fluidly connects the first chamber 42 to the chamber 36 of the suction cup 32a, 32b. The first chamber 42 houses a return member, which is here a for example helical, elastically pre-stressed spring 50, so as to induce an outlet of the rod 48 of the body 40 in the absence of counter-pressure exerted in the second chamber 44. Thus, the spring tends to bring the suction cup into its first position as shown in FIG. 1. It should be noted that another variant is shown in FIG. 6A in which the return member tends to move the suction cup to its second position.

To achieve vacuum in the chamber 36 of each of the suction cups 32, it is connected to means for providing a vacuum that includes a fluid circuit 52.

The fluid circuit 52, shown in FIG. 2 in connection with a suction cup 32a, 32b only, includes a first portion 52a for controlling the vacuum in the suction cup chamber and a second portion 52b for providing back pressure in the second chamber of the cylinder.

The fluid circuit can be a circuit for a liquid such as water. It is well understood that an air circuit is obviously simpler to operate in a device intended for use in the open air but that a liquid circuit is simpler to operate in a device intended for use in a liquid environment, such as when the device is intended for cleaning the immersed part of the hull of a boat.

The first portion 52a of the fluid circuit 52 consists of:
a first portion P1 extending between an inlet E for fluid such as pressurized air and the chamber 36 of the suction cup 32a, 32b and comprising a first valve V1 as well as from the outlet of the first valve V1 a first and a second branch E1, E2,
a second portion P2 extending between the pressurized air inlet E and a main inlet EP of a venturi tube TV having a side inlet EL, this second portion P2 comprising a second valve V2 and a third branch E3 formed between the outlet of the second valve V2 and the inlet of the venturi tube,
a third portion P3 connecting the first branch E1 and the third branch E3, the third portion P3 including a third valve V3, the valve V3 is configured to allow fluid flow only in the direction oriented towards the first branch E1,
a fourth portion P4 connecting the second branch E2 to the lateral inlet EL of the venturi tube and comprising a fourth valve V4.

The second portion 52b of the hydraulic circuit comprises a fifth portion P5 extending from the fluid pressure inlet E to an outlet S of fluid under atmospheric pressure, this fifth portion P5 successively comprising a fifth valve V5, a fourth branch E4, a flow restriction R and a sixth valve V6. As shown in FIG. 2, the fourth branch E4 is connected to the second chamber 44 of the cylinder 38 and is located between the fifth valve V5 and the restriction R. It should be noted that the sixth valve V6 and the restriction R could be reversed. Also, the restriction R is optional so that the circuit can operate without this element. Also, the device integrates means for measuring the vacuum applied in the chamber of each suction cup. These measuring devices include a pressure sensor P mounted in the first portion P1 of the hydraulic circuit and between the first chamber 42 of a cylinder 38 and the second branch E2. The pressure sensor can also be arranged between the second branch E2 and the fourth valve V4 or between the first valve V1 and the second branch E2. In practice, it is understood that the sensor P can take different positions, these positions should allow a pressure measurement in the chamber 36 of the suction cup 32a, 32b.

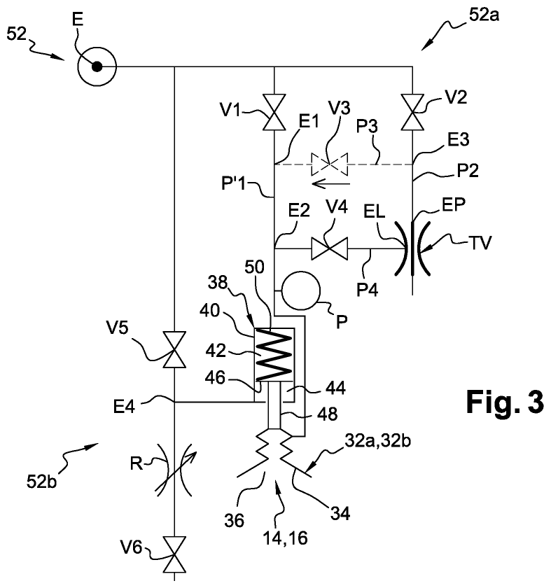

FIG. 3 shows an alternative embodiment of the hydraulic circuit 52 described with reference to FIG. 2. This differs therefrom by the direct connection of the first portion P1 to the suction cup chamber 32a, 32b without going through the first chamber 42 of the cylinder 38. The first portion is noted here as P1′.

The operation of the hydraulic system is described below relative to FIG. 2 and FIG. 3.

To move the cylinder 38 from its second position to its first position, the control means 21 control the valve V6 in opening movement in order to exhaust the pressure in the second chamber 44 of the cylinder 38 to the ambient pressure which can be the atmospheric pressure when the circuit is air and the device is used in the open air. This enables the piston 46 and the suction cup 32a, 32b to move to the first position under the effect of the support force of the spring 50 on the piston 46. The R restriction, which is optional, limits the speed of movement of the piston 46 from the second position to the first position, so that the suction cup 32a, 32b does not come into sudden contact with the surface 18, limiting the fluid outlet flow rate.

To move the piston 46 from its first position to its second position, the control means 21 control the closing of the sixth valve V6 and the opening of the fifth valve V5 in order to supply the second chamber 44 of the cylinder 38 with pressurized fluid and move the piston 46 from its first position to its second position by opposing the force exerted by the spring 50. As mentioned above, the vacuum in the chamber 36 of the suction cup 32a, 32b is controlled in such a way that it slides on the surface which it is applied on, i.e. when the member 14, 16 is in its first position. This suction effect can lead to slowing down or preventing the piston 46 from moving from its first position to its second position. Thus, the first optional valve V1 increases the pressure in the chamber 36 of the suction cup 32a, 32b, this pressurization being carried out either through the first chamber 42 of the cylinder 38 as shown in FIG. 2 or directly as shown relative to FIG. 3.

To apply vacuum to the suction cup 32a, 32b when it is positioned in its first position, the first valve V1 is in the closed position, the second valve V2 is in the open position, the fifth valve V5 is in the closed position, the third valve V3 is in the closed position, the fourth valve V4 is in the open position and the sixth valve V6 is in the open position. In this configuration, the fluid, for example the air from the chamber 36 of the suction cup 32a, 32b is sucked through the fourth valve V4 into the venturi TV, generating a pressure drop in the chamber 36 of the suction cup 32a, 32b.

In order to reduce the consumption of pressurized air in the venturi TV, the first chamber 36 can be isolated by closing the second valve V2 and closing the fourth valve V4. To this end, the pressure sensor P informs the user about the pressure evolution in the chamber 36 of the suction cup 32a, 32b, thus allowing the control of the valves V2 and V4 as previously indicated.

The third V3 valve allows, in the event of failure of the device 10, and if the valve V4 is not bidirectional, to remove the device 10 from the surface by restoring atmospheric pressure in the suction cup chamber 32a, 32b.

The fluid circuit 52 described above could still include a solenoid valve or a distributor in place of at least one of the valves described above.

As shown in the figures, the suction cups 32 are of the bellows type, which allows an elastic deformation to achieve a good adaptation of the suction cup to the surface 18. Other types of suction cups can of course be used to implement the device and the method described in this document.

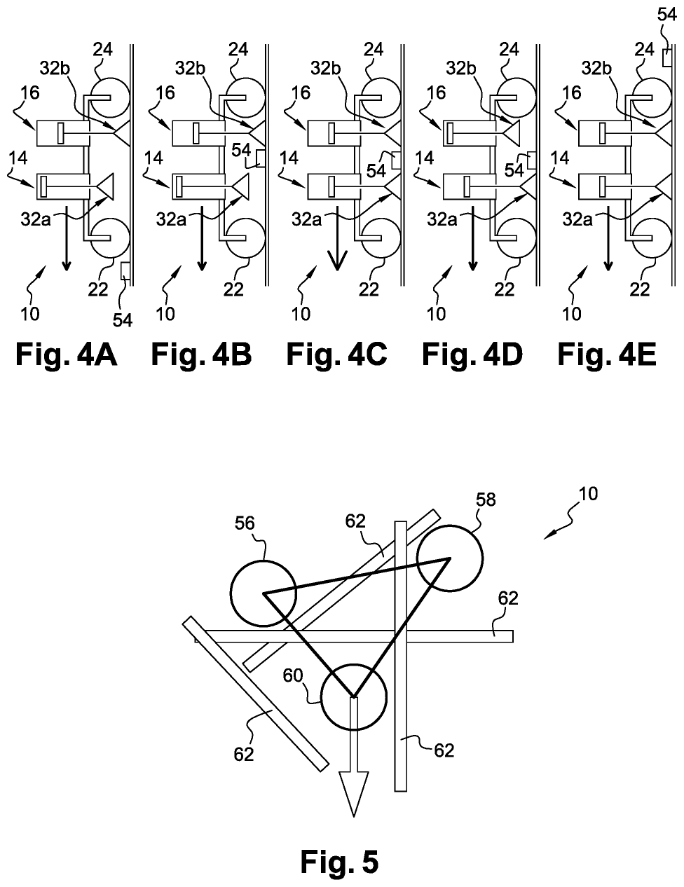

As shown in FIGS. 4A to 4E, the invention also relates to a method for slidingly moving the device on an inclined surface, the method comprising the following steps:
a) the first and second suction cups 32a, 32b being in their first position, controlling the movement of the first suction cup 32a from its first position to its second position,
b) sliding the device in a given direction so that the obstacle 54 is located between the first suction cup 32a and the second suction cup 32b in said direction of travel,
c) controlling the movement of the first suction cup 32a from its second position to its first position,
d) controlling the movement of the second suction cup 32b from its first position to its second position,
e) controlling the movement of the second suction cup 32b from its second position to its first position.

Thus, the device according to the invention allows the passing of a projecting or hollow obstacle, such as a crossbar or a groove on the external surface of a building for example.

The movement of the device on a vertical surface of a building is carried out here from the top of the building by means of the cable.

FIG. 5 represents a schematic view of the device according to the invention comprising three suction cups 56, 58, 60 in accordance with what was previously described with reference to the figures. It should be noted that the suction cups or devices for applying a vacuum are arranged in such a way as to form a triangle the vertices of which are formed by the suction cups 56, 58, 60. This arrangement allows easy overcoming of straight obstacles 62 as shown in FIG. 5.

Also, it can be noticed that with three suction cups 54, 56, 58 while using the gravity which the device 10 is subjected to, it is possible to rotate the device around a suction cup. For example, in the spatial configuration of FIG. 5, it is possible to block, i.e. to make the suction cup 58 adhere without sliding by increasing its depression, while the other two suction cups 56, 60 being slidingly controlled allow the periphery of the device 10 to be held on the surface. Rotation is made possible by the fact that the rod of the cylinder 50 is able to rotate about its axis in the body 40 of the cylinder 38.

Reference is now made to FIGS. 6A and 6B, of which FIG. 6B has already been described in FIGS. 3 and 4. The term “FIG. 6A” refers to all the FIGS. 6A1, 6A2, 6A3 and “FIG. 6B” refers to all the FIGS. 6B1, 6B2, 6B3. FIG. 6A represents an alternative embodiment of another cylinder 39 in which the return member, which can be a coil spring 50, is arranged in the second chamber and ensures a return of the suction cup 32a, 32b to its second position. The overpressure in the first chamber also enables the cylinder to be placed in the position shown in FIG. 6A2 in which the suction cup is in contact with the surface while the rolling members are not.

To control the sliding of the suction cup, it is sufficient to adjust the ratio between the tangential Tforce, depending on the weight of the device exerted on each suction cup, and the normal N force exerted on the suction cup by the depression P2 it undergoes on its surface S and which is such that N=P2·S. Thus, if the ratio T/N is higher than the sliding coefficient k of the suction cup on the contact surface, the suction cup can slip.

However, effort control alone is not N sufficient since it is not constant. Indeed, when passing an obstacle on the surface such as a crossbar, the wheels move away from the surface, i.e. windows in the case of a building, and therefore the cylinders see their position modified by a certain stroke c. Changing the stroke of the cylinders, with the suction cups in their first position, has two consequences depending on whether one is placed in the case of FIG. 6B which corresponds to case (ii) above or the case of FIG. 6A in case (i) also mentioned above.

The back pressure exerted in the first chamber (FIG. 6B) or in the second chamber (FIG. 6A) is controlled by the control means, for example by means of a fluid circuit such as that described in FIG. 2, so that different positions of the piston can be established as shown in reference to FIGS. 6A1, 6A2, 6A3, 6B1, 6B2 and 6B3.

FIGS. 6A and 6B thus represent three cylinder positions and two suction cup positions relative to the surface. FIGS. 6A1, 6A2 and 6B1, 6B2 illustrate a first position of the suction cup in which it is slidingly arranged on the surface and exerts a vacuum on the surface. FIGS. 6A2 and 6B2 illustrate the first position of the suction cup with the cylinder in a first position in which the rolling members are not in contact with the surface. FIGS. 6A1 and 6B1 show the first position of the suction cup with the cylinder in a second position in which the rolling members are in contact with the surface. FIGS. 6A3 and 6B3 show the second position of the suction cup with the cylinder in a third position in which the rolling members are in contact with the surface.

Thus, to bring a suction cup into contact with the surface, proceed as follows:
In the case of FIG. 6B2, by cancelling the overpressure in the second chamber 44, the return member ensuring a total exit of the cylinder and thus moving the piston to its first position,
In the case of FIG. 6A2, an overpressure is applied in order to oppose the return force of the return member 50 and thus move the piston to its first position.

To bring the rolling elements 22, 24 into contact with the surface, proceed as follows:
In the case of FIG. 6B1, an overpressure is applied in the second chamber in order to partially overcome the return force of the return member 50 and thus moving the piston to its second position,
In the case of FIG. 6A1, the overpressure in the first chamber is reduced so that the force of the return member 50 is partially overcome and the piston is moved to its second position.

To put the suction cup in the second position, proceed as follows:
In the case of FIG. 6B3, the overpressure in the second chamber 44 is further increased compared to FIG. 6B1 so as to crush the spring and move the piston to its third position;
In the case of FIG. 6A3, the overpressure in the first chamber 42 is cancelled so that the force of the return member can move the piston to its third position.

It should be noted that in the case of the assembly shown in FIGS. 6B1, 6B2 and 6B3, the force R exerted by the return member (in the first chamber) on the piston is opposed to the force F₁ exerted by the pressure P₁ in the second chamber or back pressure on the piston surface S₁. Similarly, in the assembly shown in FIGS. 6A1, 6A2 and 6A3, the force R exerted by the return member in the second chamber on the piston is opposed to the force F₁ exerted by the pressure P₁ on S₁ the first chamber, so that whatever the assembly (FIGS. 6B1, 6B2, 6B3 or FIGS. 6A1, 6A2, 6A3) their respective roles are equivalent. It should also be noted that in the case of the assembly of FIGS. 6A1, 6A2, 6A3, the return member is chosen to exert a plating R force of the rolling members on the surface, which is equivalent to that required in the assembly of the assembly case of FIG. 6B1, 6B2, 6B3, i.e. R=F≈P₁×S₁.

In the case of FIG. 6B, the variation of the stroke c involves:
a change in the value of the depression ΔP₂ (since the volume of the first chamber increases) which increases N and
an increase in pressure in the second chamber of the cylinder in proportion to the variation in stroke c (the effort of the recall device will decrease). This increase in pressure results in pulling more on the suction cup. The new effort F=P₁×S₁ which can lead to its disbonding when F>N.

In the case shown in FIG. 6A:
on the one hand, this leads to a decrease in the value of the vacuum (since ΔP₂ the volume of the second chamber decreases) which reduces the normal N effort and makes it easier to detach,
on the other hand, since the pressure in the cylinder ΔP₁ chamber is zero (when the suction cup is in its first sliding position and the rolling members resting on the surface), the force of the return member will increase proportionally to this variation in the stroke that c can lead to detachment when (because F>N N it is reduced).

Thus, to avoid disbonding and ensure sliding, a suction cup with a large surface S can be chosen so that the force N is very high in front F. In order to have little N variation according to the cylinder stroke, a suction cup with a large volume compared to the volume variation of the cylinder chamber (c×S₂) is chosen. Thus the vacuum P₂ varies little according to c and the force N is relatively constant despite the displacement of the cylinder according to the stroke c.

In conclusion, for the cases in FIG. 6B or 6A, the vacuum ΔP₂ must be large enough (ΔP₂>F/S) so that there is no disbonding, but not too high (T/(k·S)>P₂). It is thus possible to size the suction cup and the cylinder in such a way as to always have:

T/k<ΔP₁×S₁, where
ΔP₁ represents the overpressure in the chamber not housing the return member, and
S₁ represents the surface which said overpressure is applied on.
   As a result, only the anti-lifting test F<N remains to be monitored. This can be done by:
Measuring the pressure value in the chamber housing the return member,
Establishing whether the vacuum ΔP₂ in the chamber housing the return member is such that ΔP₂>ΔP₁×S₁/S,
   where ΔP₁ represents the overpressure in the other chamber,
   S₁ represents the surface which the overpressure ΔP₁ is applied on, and
   S represents the surface of the object which the depression ΔP₂ is applied on.
If so, stop increasing the value by ΔP₂, which can be achieved by closing the valves V2 and V4
If not, continue to increase the value of ΔP₂, what can be achieved by keeping the valves V2 and V4 in the open position.

Thus, to perform the above-mentioned single anti-lifting test, the vacuum application surface of each of said suction cups is dimensioned so that the force N is very large relative to the counter-pressure force F and wherein the volume of the chamber of each suction cup is very large relative to the volume variation that the first chamber of the cylinder undergoes between a first positioning of the device in which the rolling member(s) is/are supported on a surface on which the suction cups are in their first position and a second positioning of the device in which the rolling member(s) is/are positioned on a projecting part of the surface, the first and second suction cups being in their first position.

It should be noted that to achieve initial contact of the device with the surface of the object, it is first necessary to bring the suction cups into contact with the surface by moving them to their first position. When the suction cup is in contact with the surface of the object, the chamber 36 of the suction cup 32a, 32b is depressed. Finally, in the case of FIG. 6B, in order to bring the frame of the robotic device closer to the surface of the object and bring the rolling member(s) into contact with the surface 18, an overpressure is applied in the second chamber 44 of the cylinder 38. In the case of FIG. 6A, the overpressure in the first chamber 42 of the cylinder 39 that allowed the suction cup to move in contact with the surface is cancelled.

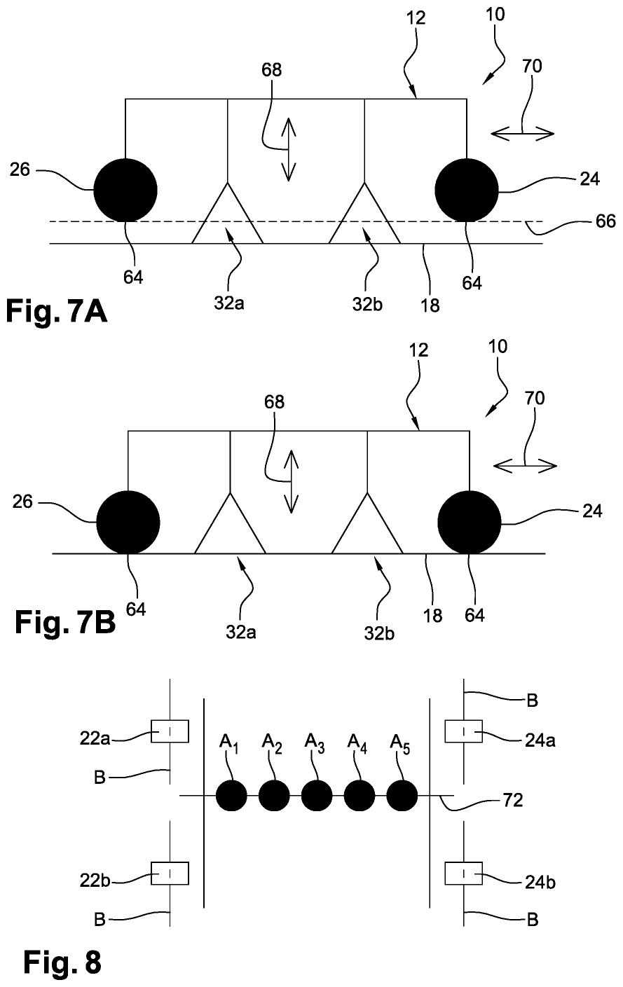

FIGS. 7A and 7B schematically illustrate the movement of the cylinders between their first position (FIG. 7A) and second position (FIG. 7B). As can be seen, the contact areas 64 with the surface 18 of said at least two rolling members 24, 26 together delimit a plane 66 through which the members 32a, 32b for applying a vacuum are mounted to move. More specifically, the members 32a, 32b for applying a vacuum are mounted to move in a direction 68 substantially perpendicular to said plane 66 and substantially perpendicular to a direction 70 of movement parallel to said plane 18.

FIG. 8 represents a particular embodiment of the invention comprising at least two, in particular four rolling members 22a, 22b, 24a, 24b, and at least five suction cups A1, A2, A3, A4, A5 located in the same plane 72 substantially perpendicular to the axes B of rotation of the rolling members and containing the centre of gravity of the device. It is mathematically demonstrable that this configuration makes it possible to pass any type of crossbar and surfaces (such as a glass pane) such that there are always at least two suction cups attached during passings with at least one of the three suction cups close to the roller and allowing on the one hand to hang on windows of minimum height and on the other hand to pass cross bars of maximum height.

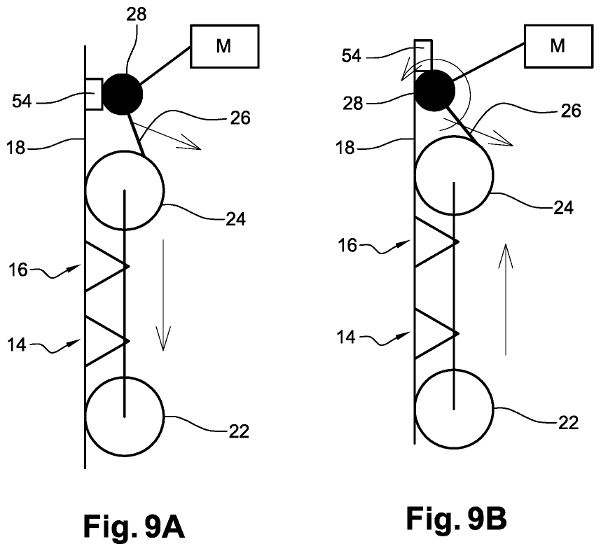

FIGS. 9A and 9B represent a variation of the device of the device described above. The arm 26 can be arranged at a rear end of the device, in the direction of descent (FIG. 9A) or at a front end of the device, in the direction of ascent (FIG. 9B). As previously described in reference to FIG. 1, the arm 26 is hinged in rotation on the frame 12 and for example elastic support means 29 (not shown in FIGS. 9A and 9B), allow the cleaning roller 28 to be kept in contact with the surface 18 which the device 10 is moved on to clean it. The vacuum application devices 32a, 32b, the fluid circuit, the rolling members, . . . can be as described relative to the previous figures without it being necessary to make a new description.

As shown, the roller 28 can be rotated by motorized means M configured to rotate the roller 28 in a counter-clockwise direction when looking at a left side flank of the device.

The device so equipped is used as follows:
Sliding the device facing a surface so that the members applying a vacuum can come into contact with the surface, the roller being arranged at an upper end of the device,
Rotating the roller in the direction of rotation tending to raise the device upwards.

It is understood that when the device is moved upwards (FIG. 9B), it is the particular direction of rotation of the roller 28 that helps to pass the obstacle 54 and to descend (FIG. 9A), the elastic support means ensure that the obstacle is passed.

1.-22. (canceled)

23. A device, in particular for cleaning a surface, for example a glass surface, comprising a frame carrying at least one rolling member and at least one first and one second member for applying a vacuum to a surface connected to means for supplying a vacuum, the first and second members being independently of one another movably mounted on the frame between a first position in which they are adapted to come into contact with a surface of an object to apply a vacuum thereto and a second position in which they are remote from said surface, the device further comprising means for controlling the vacuum of each of the first and second members in their first position configured to provide a sliding contact on the surface.

24. A device according to claim 23, wherein it comprises means for measuring the vacuum applied by each of said first and second members, said measuring means forming an input of the control means.

25. A device according to claim 23, wherein the control means are configured so that each of the first and second members applies, in their first position, a vacuum ΔP₂ such that
T/N>k, where
T represents the tangential force (in Newton) at the surface considered which is a function of the weight of the device,
N represents the normal effort (in Newton) at the surface considered and
k represents the sliding coefficient between the member of application of the vacuum and the surface under consideration.

26. A device according to one of claim 23, wherein the first member and the second member each comprise a suction cup intended to be applied to a surface of an object, and the internal chamber of which is connected to the vacuum providing means.

27. A device according to claim 23, wherein the suction cups are each fixed to the end of a rod integral with a piston sealingly separating a first and a second chambers provided in a cylinder body, and wherein:
i) the first chamber houses a, for example elastic, return member for the suction cup in its first position and the second chamber is connected to means for applying a back pressure controlled by the control means, or
ii) the second chamber houses a, for example elastic, return member for the suction cup in its second position and the first chamber is connected to means for applying a back pressure controlled by the control means.

28. A device according to claim 27, wherein the rod is hollow and fluidly connects the internal chamber of the suction cup to that of the first chamber and the second chamber housing the return member, which chamber is fluidly connected to the vacuum providing means.

29. The device according to claim 28, wherein the vacuum application surface of each of said suction cups is dimensioned so that the force N is very large relative to the back pressure force F and wherein the volume of the chamber of each suction cup is very large relative to the volume variation that the chamber housing the spring undergoes between a first positioning of the device wherein the rolling member(s) is/are supported on a surface on which the suction cups are in their first position and a second positioning of the device wherein the rolling member(s) is/are positioned on a projecting part of the surface, the first and second suction cups being in their first position.

30. A device according to claim 28, wherein the rod is rotatably mounted about the axis of the cylinder body.

31. A device according to claim 23, wherein it comprises at least two rolling members and at least two, preferably three, members for applying a vacuum are located in the same plane substantially perpendicular to the axes of rotation of the rolling members and containing the centre of gravity of the device.

32. A device according to claim 31, wherein it comprises at least five vacuum application members aligned as above.

33. A device according to claim 23, wherein it comprises at least one arm carrying a roller, preferably a cleaning roller, capable of being held in support on a surface of an object by elastic support means.

34. A device according to claim 32 wherein the roller has an axis substantially parallel to said at least one rolling member and mounted at one end of the frame with respect to a direction of movement of said device, the arm being rotatably articulated on the frame around an axis parallel to said axis of rotation of said at least one rolling member and the elastic support means ensuring an application of the roller to the surface.

35. A device according to claim 33, wherein the roller is rotated by motorized means configured to rotate the roller in a counter-clockwise direction when viewed from a left side flank of the device.

36. A device according to claim 33, wherein the arm comprises a degree of rotational freedom about an axis substantially perpendicular to the axis of rotation of said at least one rolling member.

37. A device according to claim 33, wherein it comprises means for spraying a cleaning liquid configured to spray the liquid onto the surface of an object and upstream of the cleaning roller with respect to a direction of movement of the device.

38. A device according to claim 23, comprising means for hanging the frame on a stationary structure.

39. A device according to claim 23, wherein said at least one rolling member is a wheel and wherein it preferably comprises four wheels.

40. A device according to claim 23, wherein the contact areas with the surface of said at least two rolling members together define a plane through which the members for applying a vacuum are mounted to move.

41. A device according to claim 40, wherein the members for applying a vacuum are mounted to move in a direction substantially perpendicular to said plane.

42. A method for moving the device according to claim 23 on a surface of an object having an obstacle, comprising the following steps:
a) the first and second members being in their first position, controlling the movement of the first member from its first position to its second position,
b) sliding the device in a given direction so that the obstacle is located between the first member and the second member in said direction,
c) controlling the movement of the first member from its second position to its first position,
d) controlling the movement of the second member from its first position to its second position,
e) controlling the movement of the second member from its second position to its first position.

43. A method according to claim 42, wherein step b) is carried out by means of one or more cable(s) connecting to the frame of the device.

44. A method for using the device according to claim 29, wherein it comprises:
Arranging the device opposite a surface so that the members applying a vacuum can come into contact with the surface, the first and second suction cups being moved to their first position and a vacuum being created in the chamber of each suction cup,
Moving the frame so as to apply the rolling member(s) to the surface,
Measuring the pressure value in the chamber housing the return member,
Establishing whether the vacuum ΔP₂ in the chamber housing the return member is such that ΔP₂>ΔP₁×S₁/S,
where ΔP₁ represents the overpressure in the other chamber,
S₁ represents the surface which the overpressure ΔP₁ is applied on, and
S represents the surface of the object which the depression ΔP₂ is applied on.
If so, stop increasing the value of ΔP₂
If not, continue to increase the value by ΔP₂.
